(19) United States
(12) Patent Application Publication
(10) Pub. No.: US 2026/0005548 A1
(43) Pub. Date: Jan. 1, 2026

(54) DOOR CHARGING SYSTEM

(71) Applicant: Yank Technologies, Inc., Brooklyn, NY (US)

(72) Inventors: Joshua Aaron YANKOWITZ, Brooklyn, NY (US); Benjamin TEREBELO, Brooklyn, NY (US)

(21) Appl. No.: 19/320,784

(22) Filed: Sep. 5, 2025

Related U.S. Application Data
(63) Continuation of application No. PCT/US2024/018930, filed on Mar. 7, 2024.
(60) Provisional application No. 63/488,808, filed on Mar. 7, 2023.

(51) Int. Cl. H02J 50/00; B60J 5/04; B60R 16/023; B60R 16/027; H02J 50/12

(52) U.S. Cl. CPC H02J 50/005; B60J 5/0412; B60R 16/0238; B60R 16/027; H02J 50/12

(57) ABSTRACT

Embodiments of door charging systems are described. In some aspects, a system for a removable vehicle door configured for wireless power includes a receiver antenna configured to be embedded within a door of a vehicle hinge, one or more receiver electronic housing units configured to be electrically connected to the receiver antenna, one or more transmitter electronic housing units embedded near a pillar of the vehicle and configured to be electrically connected to the transmitter antenna, and the transmitter antenna configured to be embedded within a hinge of a pillar of the vehicle.

### CROSS-REFERENCE TO RELATED APPLICATION

This application is a continuation and claims priority to International Application No. PCT/US2024/018930, filed on Mar. 7, 2024, which claims priority to U.S. Provisional Patent Application No. 63/488,808, filed on Mar. 7, 2023, the disclosure of which are hereby incorporated by reference herein in their entirety.

### TECHNICAL FIELD

The present document relates to wireless power transmission technology.

### BACKGROUND

Wireless power technology can be used to solve operational issues associated with traditional wire harnesses and connections. In the next few years, the use of wireless power solutions is expected to increase even more for a wide range of electronic devices. In this way, wireless power can be a means of enabling new features for next-generation devices.

### BRIEF SUMMARY

Techniques are disclosed for a wireless power vehicle system that can provide power to the electronics in removeable doors for greater convenience for vehicle owners and improved door reliability and reduced warranty expenditures for OEMs. In this disclosure, the terms antennas and coils are used interchangeably.

In one example aspect, a system for a removable vehicle door configured for wireless power includes a receiver antenna configured to be embedded within a door of a vehicle and placed parallel relative to a transmitter antenna, one or more receiver electronic units configured to be electrically connected to the receiver antenna and contain at least an AC-DC converter and/or a DC-DC converter and/or a voltage regulation device, one or more transmitter electronic units embedded near a pillar of the vehicle and configured to be electrically connected to the transmitter antenna and a vehicle power line, and the transmitter antenna configured to be placed parallel relative to the receiver antenna.

In another example aspect, a wireless power system includes a receiver coil configured to be embedded into a hinge of a door of a vehicle, a receiver antenna housing configured to be placed on the hinge of the door and encapsulate the receiver coil, a transmitter coil configured to be embedded into a hinge of a pillar of the vehicle, and a transmitter antenna housing configured to be placed on the hinge of the pillar and encapsulate the transmitter coil. The receiver antenna housing and the transmitter antenna housing are implemented such that the receiver coil and the transmitter coil couple when the door is interlocked with the pillar of the vehicle and the receiver coil and the transmitter coil couple to enable transfer of wireless power or electrical signals.

In another example aspect, a system includes a plurality of removable vehicle doors configured for wireless power. Each removable vehicle door includes a receiver antenna, configured to be embedded within the removable vehicle door and placed parallel relative to a corresponding transmitter antenna, and one or more receiver electronic housing units configured to be electrically connected to the receiver antenna. The system further includes a transmitter electronic housing unit configured to be electrically connected to a corresponding transmitter antenna for each of the plurality of removable vehicle doors. The system further includes a plurality of transmitter antennas. Each transmitter antenna is configured to be embedded within or near a pillar of the vehicle and placed parallel relative to a corresponding receiver antenna from the plurality of removable vehicle doors.

In another example aspect, a system includes a plurality of removable vehicle doors configured for wireless power. Each removable vehicle door includes a receiver antenna configured to be embedded within a hinge of the removable vehicle door, and one or more receiver electronic housing units configured to be electrically connected to the receiver antenna. The system further includes a transmitter electronic housing unit configured to be electrically connected to a corresponding transmitter antenna for each of the plurality of removable vehicle doors. The system further includes a plurality of transmitter antennas. Each transmitter antenna is configured to be embedded within a hinge of the pillar of the vehicle (e.g., ‘A’ pillar or ‘B’ pillar hinges). The receiver antenna and the transmitter antenna couple when the removable vehicle door is interlocked with the pillar of the vehicle and the receiver coil and the transmitter coil couple to enable transfer of wireless power or electrical signals.

These, and other, aspects are disclosed throughout the document. Furthermore, the terms antenna(s) and coil(s) are used interchangeably.

### BRIEF DESCRIPTION OF THE DRAWINGS

FIG. 1 depicts an example door charging system flow chart according to some embodiments of the disclosed technology.

FIG. 2 depicts an example door receiver system according to some embodiments of the disclosed technology.

FIG. 3 depicts an example door transmitter system according to some embodiments of the disclosed technology.

FIG. 4 depicts an example multiple door charging system according to some embodiments of the disclosed technology.

FIG. 5 depicts an example multiple door charging system with different electronic housing location according to some embodiments of the disclosed technology.

FIG. 6 depicts an example bowed Tx antenna system according to some embodiments of the disclosed technology.

FIG. 7 depicts an example bowed Rx antenna system according to some embodiments of the disclosed technology.

FIG. 8 depicts an example wireless power system method for door hinges according to some embodiments of the disclosed technology.

FIG. 9A, FIG. 9B, and FIG. 9C depict example interlocking of transmitter and receiver hinges for the door according to some embodiments of the disclosed technology.

FIG. 10 depicts different hinges that can be capable of different functions according to some embodiments of the disclosed technology.

### DETAILED DESCRIPTION

With the continued advancement of vehicles, removable door systems are becoming increasingly popular to reduce weight and improve fuel efficiency, increase the vehicles' load capacity, and enjoy off-road experiences. However, by repeatedly removing the vehicle doors, the wire harness cables and connectors weather from the mechanical stress over time. Furthermore, the environmental conditions can further reduce the reliability of the electrical connections.

A vehicle door can include many features, such the window motor, Electronic Control Unit (ECU), door locks, blind spot detection signals, turn signals, ambient lighting, and mirror power. If these electrical connections become unreliable over time, they can be potentially hazardous to the passengers and the Original Equipment Manufacturer (OEM) of the vehicle can be liable for warranty expenses associated with these issues. Furthermore, the physical disconnection of the wiring harness of the door can be cumbersome for owners to implement, especially when the cables are secured in hard-to-reach locations, such as underneath the instrument panel.

A wireless power vehicle door system can improve the robustness of removeable door systems by reducing or eliminating wire harness connections. Furthermore, this in turn can reduce warranty and/or labor costs expenditures for vehicle Original Equipment Manufacturers (OEMs).

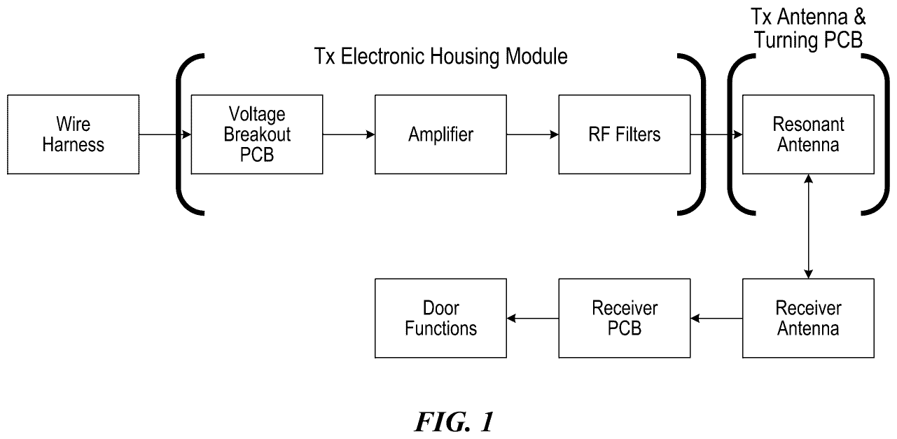

FIG. 1 illustrates an example flow chart of the wireless power system. The transmitter electronic housing is electrically connected to the wire harness of the vehicle, specifically the voltage breakout PCB. In this voltage breakout PCB, there is a step-down converter for the amplifier digital logic and a boost converter for the amplifier input. The step-down converter for the amplifier digital logic can be a buck converter or septic converter. Furthermore, the voltage breakout board can have reverse-polarity protection, EMI filters, fuse protection, and other forms of EMI, short circuit, and reverse-polarity protection circuitry.

The power amplifier can be a switching amplifier, such as a series or parallel resonant or off-resonant Class D or Class E amplifier. Additionally, the power amplifier can be single-ended or differential and can comprise an isolated switching amplifier topology. In a parallel-tuned resonant power amplifier, the load network and matching network are tuned such that the transmitter antenna is in parallel rather than in series to the resonant capacitor with the load network of the amplifier also tuned at the same resonant frequency. That is, the entire power amplifier network operates completely in resonance rather than using an off-resonant load network. This way, the voltage across the transmitter is maximized and harmonics are reduced. By maximizing the voltage, there is higher oscillating current flowing through the transmitter antenna or a stronger magnetic field to be coupled with the receiver, especially in a loose coupling resonant inductive system, such as when the transmitter and receiver are physically far apart. In some embodiments, a transformer can also be included to further increase the oscillating voltage across the transmitter antenna and thereby further improve the flux linkage and power delivery between the transmitter and receiver. Additionally, the parallel resonant power amplifier is better protected from movements or changes in the position of the receiver or capacitive and inductive reflections from the surrounding environment that could cause a substantial change in the efficiency of the power amplifier. Further details may be found in commonly owned PCT Patent Application Publication No. WO2021/178821, entitled “AUTOMOTIVE CAR SEAT WIRELESS CHARGING SYSTEM,” which is incorporated by reference herein.

The amplifier can then be electrically coupled to RF filters, such as bandpass filters, to attenuate undesirable harmonics and spurious signals. Furthermore, it can operate at multiple frequencies, such as 85 kHz, 100 kHz, 6.78 MHz, 13.56 MHz, or 27.12 MHz. The signal then couples with antenna(s) tuned with resonant capacitors and matched to the optimal impedance of the system. These capacitive and potentially inductive parts for tuning and matching can be consolidated into a transmitter antenna matching and tuning PCB.

Furthermore, some or all of the features described in the transmitter electronic housing can be incorporated into a single consolidated or separated PCBs within the transmitter electronic housing module. In addition, the transmitter electronic housing module can be partitioned into a single or several electronic housing modules for easier assembly if applicable.

The receiver antenna(s) are excited with capacitors to substantially resonate, match, and capture the flux from the transmitter antenna(s). This signal is then electrically connected to an AC-DC converter and regulator for various voltage levels depending on the application, but typically 12V for within the vehicle.

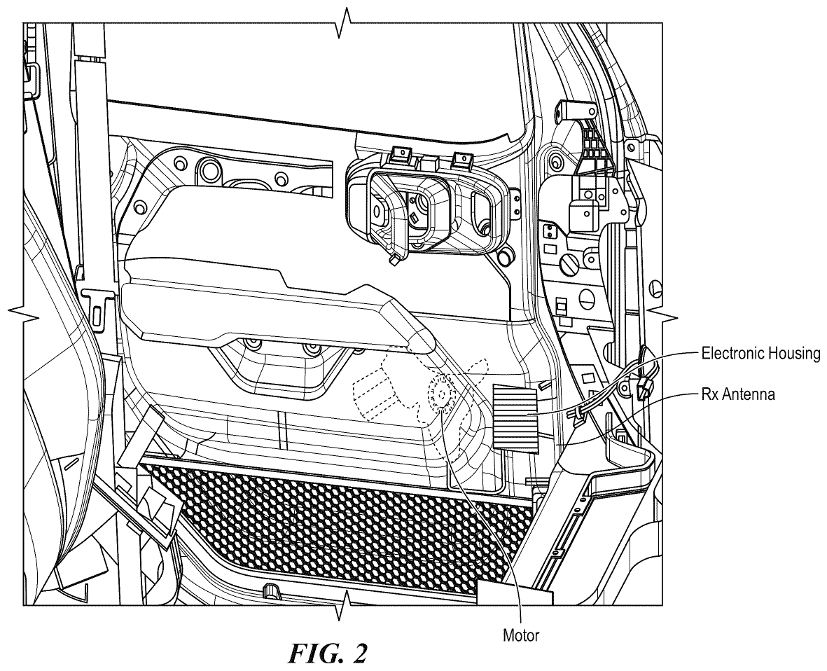

FIG. 2 illustrates an example door receiver system. The receiver (Rx) antenna is embedded into the door such that it is approximately parallel to the transmitter antenna. The Rx antenna is electrically connected to one or more electronic housing units that contain the AC-DC converter and/or DC-DC converter and/or voltage regulation device electrically connected to door features, such as the window motor and ECU. Lastly, while a single motor function in the example illustration is shown, there may be several motors, ECUs, ambient lightning, blind spot detectors, and other vehicle functions embedded in the vehicle car door that are powered by the wireless power system. A single motor function is only shown for simplicity.

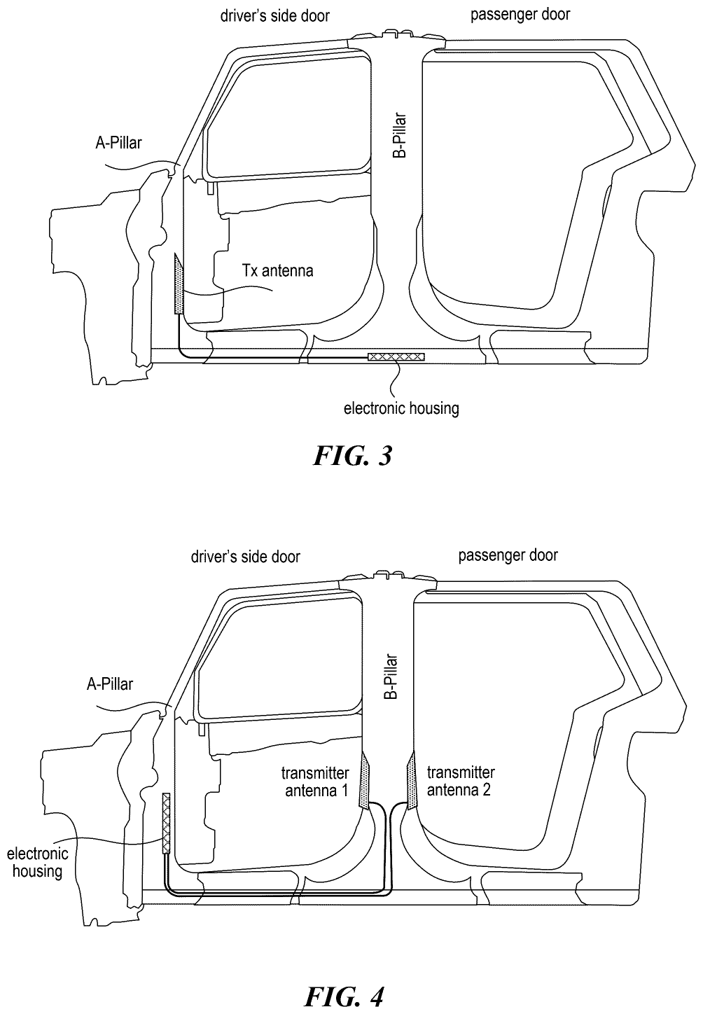

FIG. 3 illustrates an example door transmitter system. The transmitter electronic housing can be embedded near the A-pillar, B-pillar, vehicle floor, and instrument panel of the vehicle and electrically connected to one or more antennas and tuning and matching PCBs. The transmitter antenna is approximately parallel to the receiver antenna embedded into the door such that they can significantly couple with one another. The transmitter tuning and matching capacitors can be integrated directly to the Tx antenna or physically mounted closer to the antenna as a separate PCB and housing in order to place these capacitors physically closer to the excited antenna.

FIG. 4 illustrates an example multiple door charging system. The transmitter system can also be developed such that a single transmitter electronic housing unit drives multiple transmitter antennas to power multiple doors simultaneously. In this instance the transmitter antennas can be embedded into different pillars of the vehicle, such as the B-pillar of the vehicle. Furthermore, not shown in FIG. 4, the transmitter antennas can be embedded into different pillars simultaneously, such as the A pillar for the drivers' side door and the B-pillar for the passenger door. The transmitter antenna(s) locations depend on the integration location of the receiver antenna within the door itself with again the primary focus being that the antennas significantly couple with one another for optimal power delivery.

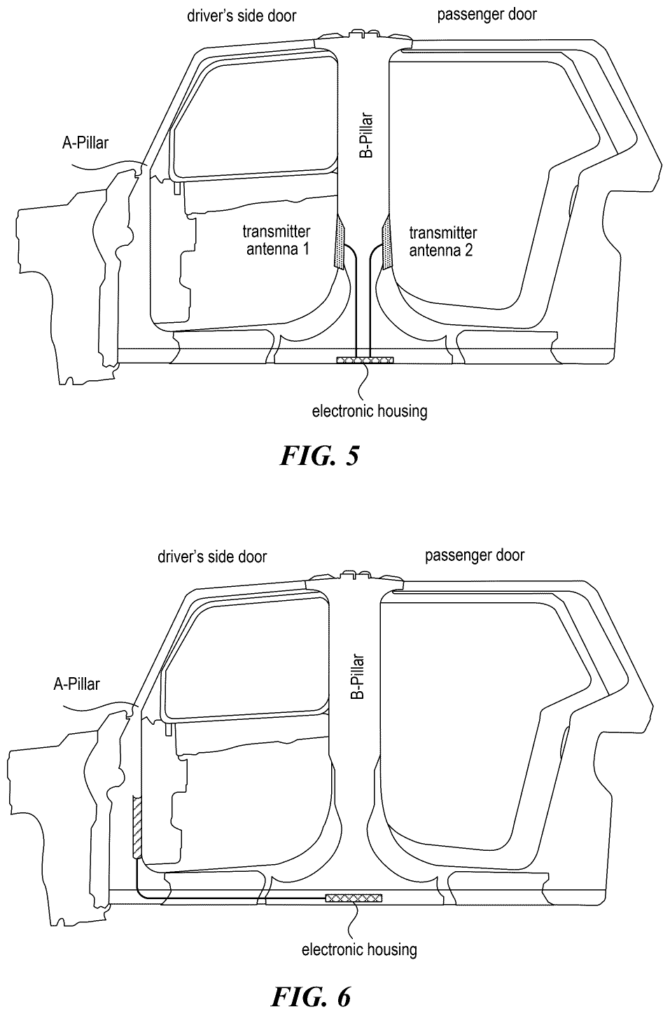

FIG. 5 illustrates an example multiple door charging system with different electronic housing locations. Furthermore, the electronic housing location can vary depending on the optimal location in the vehicle in terms of cost, packaging space, and durability. FIG. 5 illustrates another mounting location for the transmitter electronics underneath the floor near the B-pillar area.

FIG. 6 illustrates an example bowed Tx antenna system. Given that the door pivots along the axis, it may be desirable to power the door electronics while the door is open or in motion. For example, it may be desirable to change the positioning of the window or mirror while the door is open. Furthermore, many vehicle manufacturers have ambient lighting and logo illumination features while the door is open. In this case, it would be necessary to design the transmitter and/or the receiver antennas such that they are physically positioned to couple significantly with one another for these positions. FIG. 6 illustrates an example embodiment of curved or “bowed” transmitter antenna in order to couple better with the receiver antenna while the door is open or in motion. This is applicable for all doors in the vehicle for two and four door vehicles.

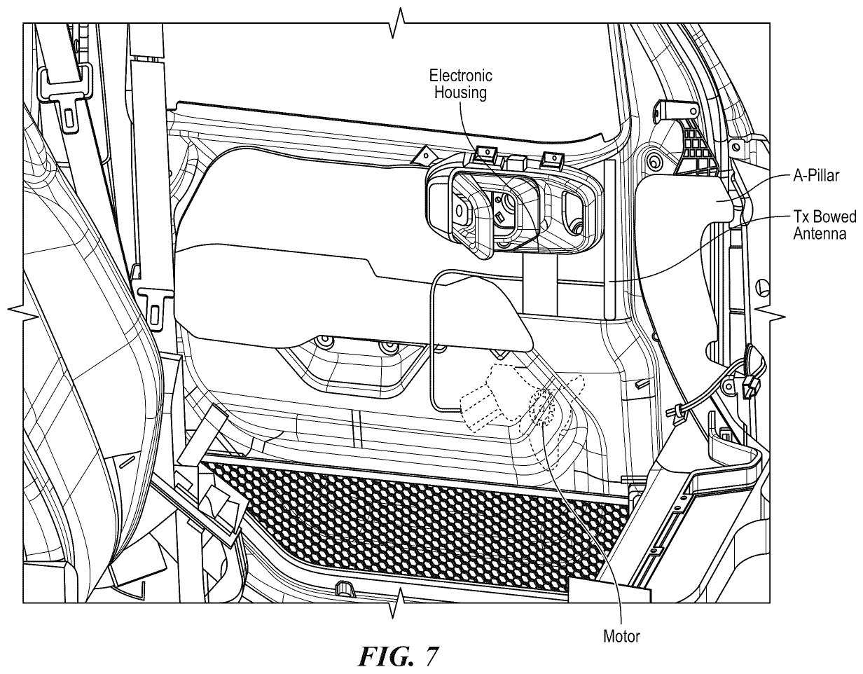

FIG. 7 illustrates an example bowed Rx antenna system. In addition, a curved or “bowed” receiver antenna may also be helpful to capture the flux from the transmitter while the door is opened. An example embodiment of a bowed Rx antenna is illustrated in FIG. 7. In this instance, it could be beneficial for the transmitter antenna to be planar or bowed. Furthermore, there can be bowed receiver and transmitter antennas for different areas of the vehicle depending on the features of the door, power requirements, packaging constraints, and cost implications of different areas of the vehicle. Lastly, while a single motor function in the example illustration is shown, there may be several motors, ECUs, ambient lightning, blind spot detectors, and other vehicle functions embedded in the vehicle car door that are powered by the wireless power system. A single motor function is only shown for simplicity.

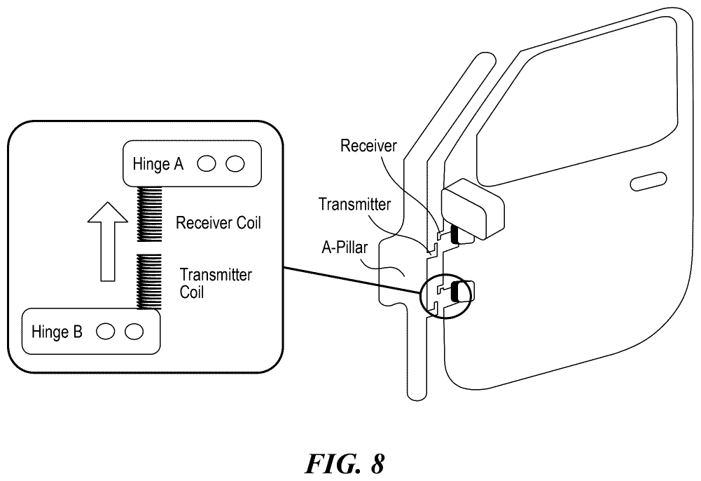

FIG. 8 illustrates an example wireless power system for door hinges. There may also be instances in which an inductive rather than resonant inductive method is preferred whereby the transmitter and receiver antennas are embedded into the door hinges. This may be a preferable method for lower power door applications due to the reduced complexity and cost of the system. For higher power applications (e.g., greater than 200 Ws), it may be preferable to use a resonant inductive system, such as the previously described embodiments, or the proposed system in FIG. 8 whereby the transmitter and receiver coils are also substantially excited by capacitors at the desired resonant frequency.

In FIG. 8, the Receiver Coil is embedded into the hinge on the door, while the Transmitter Coil is embedded into the hinge mounted on the vehicle, such as the ‘A’ or ‘B’ pillar. When the door is interlocked with the pillar of the vehicle, the Transmitter and Receiver Coils substantially couple with one another in a similar function to the primary and secondary windings of a transformer. A further benefit of this is that the transmitter and receiver may highly couple with one another for all door positions (e.g., while the door is opened, partially opened, and closed). This is because the relative distance and angle between the transmitter and receiver coils does not significantly change since the door rotates on the axis of the hinges itself.

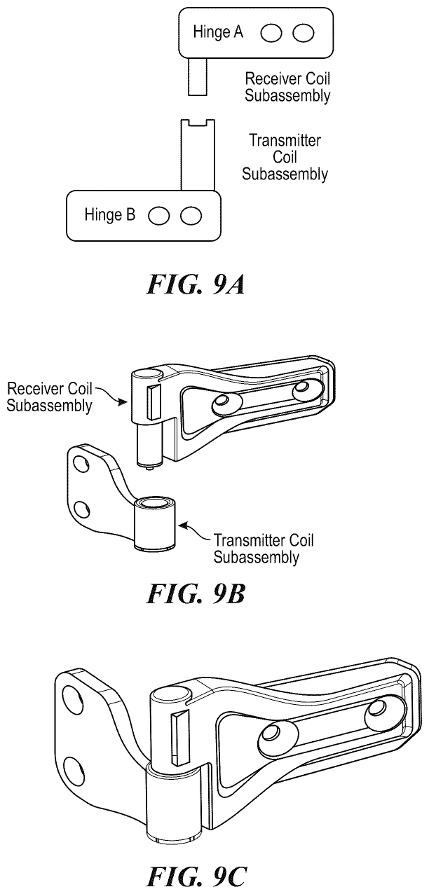

FIG. 9A, FIG. 9B, and FIG. 9C illustrates an example interlocking of transmitter and receiver hinges for the door. FIG. 9A, FIG. 9B, and FIG. 9C illustrate that the Transmitter and Receiver Coils may be potted or securely protected from environmental conditions with the Transmitter and Receiver Coil Housings or Subassemblies respectively. These housings are also designed such that the hinges interlock with one another.

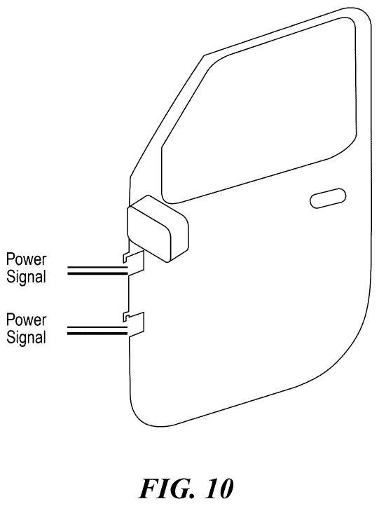

FIG. 10 illustrates different hinges can be capable of different functions. Furthermore, it is also possible that the wireless power system for door hinge embodiments exhibit different functions for the same or different doors in the vehicle. FIG. 10 illustrates that one Tx/Rx door hinge is powering the door functions while a second Tx/Rx door hinge is providing the electrical signals for passing data to the door electronic control unit. There may also be embodiments whereby multiple hinges are used for transferring power to reduce the power dissipated and in turn improve the thermal operation for each Tx/Rx hinge in the system or to alter the polarity for different vehicle functions (e.g., the movement of the window up and down).

The following listing of solutions may be preferably implemented by some embodiments.
1. A system for a removable vehicle door configured for wireless power, comprising: a receiver antenna configured to be embedded within a door of a vehicle and placed parallel relative to a transmitter antenna; one or more receiver electronic units configured to be electrically connected to the receiver antenna and contain at least an AC-DC converter and/or a DC-DC converter and/or a voltage regulation device; one or more transmitter electronic units embedded near a pillar of the vehicle and configured to be electrically connected to the transmitter antenna and a vehicle power line; and the transmitter antenna configured to be placed parallel relative to the receiver antenna.
2. The system of solution 1, wherein the receiver antenna is configured to be excited with one or more capacitors to resonate and capture flux from the transmitter antenna.
3. The system of solutions 1-2, wherein the transmitter antenna is curved in order to couple with the receiver antenna while the door is open or pivoting in motion along an axis.
4. The system of solutions 1-3, wherein the receiver antenna is curved in order to couple with the transmitter antenna while the door is open or pivoting in motion along the axis.
5. A wireless power system, comprising: a receiver coil configured to be embedded into a hinge of a door of a vehicle; a receiver antenna housing configured to be placed on the hinge of the door and encapsulate the receiver coil; a transmitter coil configured to be embedded into a hinge of a pillar of the vehicle; and a transmitter antenna housing configured to be placed on the hinge of the pillar and encapsulate the transmitter coil; wherein: the receiver antenna housing and the transmitter antenna housing are implemented such that the receiver coil and the transmitter coil (e.g., are encapsulated and protected from environmental conditions like dust and dirt) and couple when the door is interlocked with the pillar of the vehicle and the receiver coil and the transmitter coil couple to enable transfer of wireless power or electrical signals.
6. The system of solution 5, wherein the receiver coil and the transmitter coil couple to enable transfer of wireless power, and wherein a second receiver coil and a second transmitter couple to enable transfer of wireless electrical signals.
7. The system of solutions 5-6, wherein: the transmitter coil is electrically connected to one or many transmitter electronics, which include an amplifier, RF filter, and impedance matching network, that is electrically connected to the vehicle power line; and the receiver coil is electrically connected to one or many receiver electronics, which include an AC-DC converter and/or a DC-DC converter and/or a voltage regulation device.
8. The system of solutions 5-7, wherein the receiver coil and the transmitter coil couple to enable transfer of wireless power via an inductive method.
9. The system of solution 8, wherein the inductive method is used for power applications requiring less than 100 watts.
10. The system of solutions 5-7, wherein the receiver coil and the transmitter coil are excited by one or more capacitors at a desired resonant frequency to enable transfer of wireless power via a resonant inductive method.
11. The system of solution 10, wherein the resonant inductive method is used for power applications requiring more than 100 watts.
12. The system of solutions 5-10, wherein the receiver antenna housing and the transmitter antenna housing are placed such that the receiver coil and the transmitter coil are substantially protected from environmental conditions like dust and dirt and couple when the door is door is opened, partially opened, and/or closed.
13. A system, comprising: a plurality of removable vehicle doors configured for wireless power, each removable vehicle door comprising: a receiver antenna configured to be embedded within the removable vehicle door and placed parallel relative to a corresponding transmitter antenna; and one or more receiver electronic housing units configured to be electrically connected to the receiver antenna; a transmitter electronic housing unit configured to be electrically connected to a corresponding transmitter antenna for each of the plurality of removable vehicle doors; and a plurality of transmitter antennas, each transmitter antenna configured to be embedded within or near a pillar of the vehicle and placed parallel relative to a corresponding receiver antenna from the plurality of removable vehicle doors.
14. The system of solution 13, wherein one or more receiver antennas are configured to be excited with one or more capacitors to resonate and capture flux from the corresponding transmitter antenna.
15. The system of solutions 13-14, wherein one or more transmitter antennas are curved in order to couple with the corresponding receiver antenna while the door is open or pivoting in motion along an axis.
16. The system of solutions 13-15, wherein one or more receiver antennas are curved in order to couple with the corresponding transmitter antenna while the door is open or pivoting in motion along the axis.
17. The system of solutions 13-16, wherein the one or more receiver electronic housing units include an AC-DC converter and/or a DC-DC converter and/or a voltage regulation device electrically connected to one or more door features.
18. The system of solution 17, wherein the one or more door features include a window motor, mirror motor, an electronic control unit (ECU), ambient lighting, and/or logo illumination.
19. The system of solutions 3-18, wherein one or more transmitter antenna configured to be embedded within or near the pillar of the vehicle includes at least one transmitter antenna configured to be embedded within a floor of the vehicle near the pillar of the vehicle.
20. A system, comprising: a plurality of removable vehicle doors configured for wireless power, each removable vehicle door comprising: a receiver antenna configured to be embedded within a hinge of the removable vehicle door; and one or more receiver electronic housing units configured to be electrically connected to the receiver antenna; a transmitter electronic housing unit configured to be electrically connected to a corresponding transmitter antenna for each of the plurality of removable vehicle doors; and a plurality of transmitter antennas, each transmitter antenna configured to be embedded within a hinge of a pillar of the vehicle wherein the receiver antenna and the transmitter antenna couple when the removable vehicle door is interlocked with the pillar of the vehicle and the receiver antenna and the transmitter antenna couple to enable transfer of wireless power or electrical signals.
21. The system of solution 20, wherein one or more receiver antennas are configured to be excited with one or more capacitors to resonate and capture flux from the corresponding transmitter antenna.
22. The system of solutions 20-21, wherein the one or more receiver electronic housing units include an AC-DC converter and/or a DC-DC converter and/or a voltage regulation device electrically connected to one or more door features.
23. The system of solution 22, wherein the one or more door features include a window motor, mirror motor, an electronic control unit (ECU), ambient lighting, and/or logo illumination.

The figures and above description provide a brief, general description of a suitable environment in which the invention can be implemented. The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations can perform routines having steps/blocks, or employ systems having blocks, in a different order, and some processes or blocks can be deleted, moved, added, subdivided, combined, or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges.

These and other changes can be made to the invention in light of the above Detailed Description. While the above description describes certain examples of the invention, and describes the best mode contemplated, no matter how detailed the above appears in text, the invention can be practiced in many ways. Details of the system can vary considerably in its specific implementation, while still being encompassed by the invention disclosed herein. As noted above, terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A system for a removable vehicle door configured for wireless power, comprising:
a receiver antenna configured to be embedded within a door of a vehicle and placed parallel relative to a transmitter antenna;
one or more receiver electronic units configured to be electrically connected to the receiver antenna and contain at least an AC-DC converter and/or a DC-DC converter and/or a voltage regulation device;
one or more transmitter electronic units embedded near a pillar of the vehicle and configured to be electrically connected to the transmitter antenna and a vehicle power line; and
the transmitter antenna configured to be placed parallel relative to the receiver antenna.

2. The system of claim 1, wherein the receiver antenna is configured to be excited with one or more capacitors to resonate and capture flux from the transmitter antenna.

3. The system of claim 1, wherein the transmitter antenna is curved in order to couple with the receiver antenna while the door is open or pivoting in motion along an axis.

4. The system of claim 1, wherein the receiver antenna is curved in order to couple with the transmitter antenna while the door is open or pivoting in motion along an axis.

5. A wireless power system, comprising:
a receiver coil configured to be embedded into a hinge of a door of a vehicle;
a receiver antenna housing configured to be placed on the hinge of the door and encapsulate the receiver coil;
a transmitter coil configured to be embedded into a hinge of a pillar of the vehicle; and
a transmitter antenna housing configured to be placed on the hinge of the pillar and encapsulate the transmitter coil;
wherein:
the receiver antenna housing and the transmitter antenna housing are implemented such that the receiver coil and the transmitter coil couple when the door is interlocked with the pillar of the vehicle and the receiver coil and the transmitter coil couple to enable transfer of wireless power or electrical signals.

6. The system of claim 5, wherein the receiver coil and the transmitter coil couple to enable transfer of wireless power, and wherein a second receiver coil and a second transmitter couple to enable transfer of wireless electrical signals.

7. The system of claim 5, wherein:
the transmitter coil is electrically connected to one or many transmitter electronics, which include an amplifier, RF filter, and impedance matching network, that is electrically connected to a vehicle power line; and
the receiver coil is electrically connected to one or many receiver electronics, which include an AC-DC converter and/or a DC-DC converter and/or a voltage regulation device.

8. The system of claim 5, wherein the receiver coil and the transmitter coil couple to enable transfer of wireless power via an inductive method.

9. The system of claim 8, wherein the inductive method is used for power applications requiring less than 100 watts.

10. The system of claim 5, wherein the receiver coil and the transmitter coil are excited by one or more capacitors at a desired resonant frequency to enable transfer of wireless power via a resonant inductive method.

11. The system of claim 10, wherein the resonant inductive method is used for power applications requiring more than 100 watts.

12. The system of claim 5, wherein the receiver antenna housing and the transmitter antenna housing are placed such that the receiver coil and the transmitter coil are substantially protected from environmental conditions like dust and dirt and couple when the door is door is opened, partially opened, and/or closed.

13. A system, comprising:
a plurality of removable vehicle doors configured for wireless power, each removable vehicle door comprising:
a receiver antenna configured to be embedded within the removable vehicle door and placed parallel relative to a corresponding transmitter antenna; and
one or more receiver electronic housing units configured to be electrically connected to the receiver antenna;
a transmitter electronic housing unit configured to be electrically connected to a corresponding transmitter antenna for each of the plurality of removable vehicle doors; and
a plurality of transmitter antennas, each transmitter antenna configured to be embedded within or near a pillar of the vehicle and placed parallel relative to a corresponding receiver antenna from the plurality of removable vehicle doors.

14. The system of claim 13, wherein one or more receiver antennas are configured to be excited with one or more capacitors to resonate and capture flux from the corresponding transmitter antenna.

15. The system of claim 13, wherein one or more transmitter antennas are curved in order to couple with the corresponding receiver antenna while the door is open or pivoting in motion along an axis.

16. The system of claim 13, wherein one or more receiver antennas are curved in order to couple with the corresponding transmitter antenna while the door is open or pivoting in motion along an axis.

17. The system of claim 13, wherein the one or more receiver electronic housing units include an AC-DC converter and/or a DC-DC converter and/or a voltage regulation device electrically connected to one or more door features.

18. The system of claim 17, wherein the one or more door features include a window motor, an electronic control unit (ECU), ambient lighting, and/or logo illumination.

19. The system of claim 13, wherein one or more transmitter antenna configured to be embedded within or near the pillar of the vehicle includes at least one transmitter antenna configured to be embedded within a floor of the vehicle near the pillar of the vehicle.
